(19) United States
(12) Patent Application Publication
(10) Pub. No.: US 2018/0337734 A1
(43) Pub. Date: Nov. 22, 2018

(54) OPTICAL LINE TERMINAL AND OPTICAL NETWORK UNIT

(71) Applicant: Alcatel Lucent, Nozay (FR)

(72) Inventor: Zhensen GAO, Shanghai (CN)

(73) Assignee: Alcatel Lucent, Nozay (FR)

(21) Appl. No.: 15/776,973

(22) PCT Filed: Nov. 18, 2016
(86) PCT No.: PCT/IB2016/001804

§ 371 Date: May 17, 2018

(30) Foreign Application Priority Data
Nov. 20, 2015 (CN) 201510815714.2

(51) Int. Cl. H04B 10/50; H04B 10/54; H04B 10/27; H04J 14/02; H04J 14/08

(52) U.S. Cl. CPC H04B 10/504; H04B 10/54; H04J 14/08; H04J 14/02; H04B 10/27

(57) ABSTRACT

A transmitter for an optical network unit, includes a 2.5 Gb/s direct modulation laser, for generating an uplink optical signal; wherein the direct modulation laser is driven by a modulation current and a bias current, and the bias current is configured to be greater than a threshold current of the direct modulation laser, and an amplitude of the modulation current is such configured that a difference between a frequency of 1 bit and a frequency of 0 bit of the uplink optical signal is a half of a transmission rate of the uplink optical signal.

### TECHNOLOGY

The embodiments of the present disclosure relate to Time- and Wavelength-Division Multiplexed Passive Optical Network (TWDM-PON) system, and particularly to an optical line terminal (OLT) and an optical network unit (ONU) in a TWDM-PON system.

### BACKGROUND

TWDM-PON has been recently selected as the primary technology for NG-PON2 by the ITU-T community due to its cost effectiveness and backward compatibility with the legacy GPON/XGPON. In the initial stage, TWDM-PON targets to offer an aggregate capacity of 40 Gbp/s in the downlink and 10 Gbp/s in the uplink by multiplexing four wavelength channel pairs, where each wavelength pair is modulated at 2.5 Gb/s for the uplink, and 10 Gb/s for the downlink.

However, in order to satisfy the demand of future bandwidth consuming services, it becomes necessary for future TWDM-PON to provide 10 Gbp/s per wavelength in the uplink to realize a 40 Gbp/s symmetric TWDM-PON. Additionally, in the specification ITU-T G.989.2 for TWDM-PON, it is also desirable that the transmission distance between the OLT and ONU is larger than 40 km and the splitting ratio is not less than 1:64. The ONU uplink transmitter is the key technology to meet these requirements in a symmetric TWDM-PON system.

Traditionally, the external modulation such as the Mach-Zehnder (MZM) modulator or electro-absorption modulator (EML) is the candidate approach for a long reach transmission with 10 Gb/s per uplink wavelength channel. But these modulators are either polarization sensitive or quite expensive for practical use in TWDM-PON. Compared with the abovementioned transmitters, a directly modulated laser (DML), such as a distributed feedback laser (DFB laser), is a very attractive candidate for TWDM-PON as it is tunable and of low cost.

However, most of the commercial DMLs are operated at 2.5 Gb/s, so the 2.5 Gb/s DMLs of four stacked uplink multiple wavelength optical signals can only generate a 10 Gb/s uplink capacity for a symmetric TWDM-PON. It is very hard to directly use a low speed 2.5 Gb/s DML to generate high speed 10 Gb/s uplink signals for a symmetric 40 Gb/s TWDM-PON system due to its low modulation efficiency, a pulse spreading induced by the strong frequency chirp and the transmission performance deterioration.

Intuitively, a high speed 10 Gb/s DML can be used for a 10 Gb/s uplink signal transmission to realize a symmetric 40 Gb/s TWDM-PON system. But its cost is about 2-3 times than the price of a 2.5 Gb/s DML. What's more, a 10 Gb/s DML also severely suffers from the frequency chirp. The transmission distance for a typical 10 Gb/s DML is limited to <20 km and the splitting ratio in the PON system is greatly reduced, which is incompatible with the NG-PON2 requirement. Since the TWDM-PON is very cost sensitive, it is attractive but very challenging to use a commercial low speed 2.5 Gb/s DML to transmit 10 Gb/s uplink signals over a fiber, which is longer than 40 km for example, to realize a long reach 40 Gb/s symmetric TWDM-PON system with a high splitting ratio.

### SUMMARY

In view of the existing technical problem in the prior art, the embodiment of the present disclosure provides a symmetric TWDM-PON system with an extended transmission distance (>40 km, for example) and a high splitting ratio (>1:64, for example). Further, in this system, a very low speed and low cost 2.5 Gb/s DML laser is used.

According to a first aspect of the present disclosure, it is proposed a transmitter for an optical network unit, comprising: a 2.5 Gb/s direct modulation laser, for generating an uplink optical signal; wherein the direct modulation laser is driven by a modulation current and a bias current, and the bias current is configured to be greater than a threshold current of the direct modulation laser, and an amplitude of the modulation current is configured such that a difference between a frequency of 1 bit and a frequency of 0 bit of the uplink optical signal is a half of a transmission rate of the uplink optical signal.

According to an embodiment of the present disclosure, the direct modulation laser comprises a distributed feedback laser or a distributed Bragg reflector.

According to an embodiment of the present disclosure, the bias current is configured to be at least three times of the threshold current of the direct modulation laser.

According to an embodiment of the present disclosure, the bias current is configured to be three to five times of the threshold current of the direct modulation laser.

According to an embodiment of the present disclosure, data carried by the modulation current is in an On-Off Keying format.

According to an embodiment of the present disclosure, the amplitude of the modulation current is configured based on physical parameters of the direct modulation laser.

According to a second aspect of the present disclosure, it is proposed a receiver for an optical line terminal, comprising: an arrayed waveguide grating; and N receiving units; wherein the arrayed waveguide grating is used to equalize an uplink optical signal, and transmit N uplink multiple wavelength optical signals to the N receiving units respectively, wherein the uplink optical signal is generated by a 2.5 Gb/s direct modulation laser; and wherein a center frequency of each of N pass-bands of the arrayed waveguide grating has an offset with respect to a frequency of a corresponding uplink multiple wavelength signal, and a 3 dB bandwidth of each of the N pass-bands of the arrayed waveguide grating is in a range of 17 GHz to 33 GHz.

According to an embodiment of the present disclosure, the 3 dB bandwidth of each of the N pass-bands of the arrayed waveguide grating is 25 GHz.

According to an embodiment of the present disclosure, the offset between the center frequency of each of the N pass-bands of the arrayed waveguide grating and the frequency of the corresponding uplink multiple wavelength optical signal is in a range of 25 GHz to 35 GHz.

According to an embodiment of the present disclosure, the offset is 30 GHz.

According to an embodiment of the present disclosure, N equals to 4 or 8.

According to an embodiment of the present disclosure, an order of a filter of each of the N pass-bands of the arrayed waveguide grating is at least 2.

According to an embodiment of the present disclosure, the receiver further comprises: an optical amplifier for amplifying the uplink optical signal and outputting it to the arrayed waveguide grating.

According to an embodiment of the present disclosure, the direct modulation laser is driven by a modulation current and a bias current, and the bias current is configured to be greater than a threshold current of the direct modulation laser, and an amplitude of the modulation current is configured such that a difference between a frequency of 1 bit and a frequency of 0 bit of the uplink optical signal is a half of a transmission rate of the uplink optical signal.

According to a third aspect of the present disclosure, it is proposed an optical network unit, comprising: a transmitter according to the present disclosure; a receiver; and a wavelength division multiplexer connected with the transmitter and the receiver respectively.

According to a fourth aspect of the present disclosure, it is proposed an optical line terminal, comprising: a receiver according to the present disclosure; a transmitter; and a wavelength division multiplexer connected with the transmitter and the receiver respectively.

According to a fifth aspect of the present disclosure, it is proposed an optical network architecture, comprising: N optical network units according to the present disclosure; a splitter; and an optical line terminal according to the present disclosure; wherein the optical line terminal is connected with the N optical network units via the splitter.

Herein, the embodiment of the present disclosure provides a new scheme for a symmetric TWDM-PON system with an extended transmission distance, which uses a very low speed and low cost 2.5 Gb/s DML as a transmitter. The advantages of the embodiments of the present disclosure are at least in that:

1. A 10 Gb/s high speed uplink data transmission is accomplished by using a low cost and low speed 2.5 Gb/s DML as a transmitter to realize a long reach 40 Gb/s symmetric TWDM-PON. Herein, no high speed and expensive optical transmitter is required to be installed at the optical network unit.

2. Moreover, the embodiments of the present application can further support ever higher transmission speed above 10 Gb/s such as 20 Gb/s. For example, a low speed 2.5 Gb/s DML can be used for a 80 Gb/s symmetric TWDM-PON.

3. A single arrayed waveguide grating (AWG) is used at the OLT to simultaneously perform dual-functions of wavelength demultiplexing and optical equalization to extend the transmission distance and thus enhance the splitting ratio in the long reach symmetric TWDM-PON system.

4. The transmission performance of multiple uplink wavelength optical signals at the OLT for the long reach PON is centralized improved.

5. Metro-access convergence for a future access network evolution is enabled.

6. The optical distribution network (ODN) remains passive and no active components are introduced in the remote node for the long reach symmetric TWDM-PON.

The respective aspects of the embodiments of the disclosure will be clear through the illustration of the detailed embodiments below.

### BRIEF DESCRIPTION OF THE DRAWINGS

Other features, objects and advantages of the invention will become more apparent upon review of the following detailed description of non-limiting embodiments taken with reference to the drawings in which:

FIG. 1 illustrates a network architecture of a symmetric TWDM-PON system according to an embodiment of the present disclosure;

FIG. 2 illustrates the relationship between a spectrum response of a conventional AWG according to an embodiment of the present disclosure, a spectrum response of an AWG according to an embodiment of the present disclosure and multiple wavelength optical signals;

FIG. 3 illustrates a spectrum response of a conventional AWG according to another embodiment of the present disclosure and a spectrum response of an AWG according to an embodiment of the present disclosure;

FIG. 4 illustrates the spectrums of the uplink optical signal before and after the AWG according to an embodiment of the present disclosure;

FIG. 5 illustrates the waveforms of the uplink optical signal before and after the AWG according to a further embodiment of the present disclosure;

FIGS. 6(a) to 6(i) illustrate eye diagrams and BER diagrams under the respective condition when the bit rate is 10 Gb/s according to an embodiment of the present disclosure; and

FIG. 7 illustrates eye diagrams and BER diagrams under the respective condition when the bit rate is 20 Gb/s and 30 Gb/s according to an embodiment of the present disclosure.

In the drawings, identical or like reference numerals denote identical or corresponding components or features throughout the different figures.

### DETAILED DESCRIPTION

The basic idea of the embodiments of the disclosure is in that:

1. Unlike the traditional concept of using a high speed transmitter for a high speed uplink transmission, only a low speed and low cost 2.5 Gb/s DML is used at the ONU transmitter side to transmit 10 Gb/s or even above uplink Non-Return to Zero On-Off Keying (NRZ-OOK) (i.e. a binary optical intensity modulation format) optical signals for a 40 Gb/s or beyond symmetric TWDM-PON system. No any high speed optical component is used at the ONU so as to save the cost.

2. In the prior art, the bias current of the DML is near the threshold current of the DML and the conventional laser is modulated with a current with a high amplitude, which carries the data, to get a high extinction ratio. By contrast, in the embodiments of the present disclosure, the low speed 2.5 Gb/s DML is driven by a higher bias current, and modulated with a relatively small modulation current, which carries the data. The bias current is selected to be several times (at least 3 times, for example) of the threshold current to boost the output power and enhance the resonance frequency. Moreover, the modulation current is properly optimized according to the DML physical parameters to induce a frequency chirp of about a half of the bit rate.

3. At the OLT receiver side, a special AWG according to the embodiment of the present disclosure is used. This AWG is used not only as a wavelength de-multiplexer but also as an optical equalizer to centrally improve the transmission performance of the distorted high speed uplink NRZ-OOK signal. The 3 dB bandwidth and center frequency of the special AWG are different from those of the traditional AWG. In the AWG according to the embodiment of the present disclosure, the center frequency of each pass-band is no longer precisely aligned with the corresponding uplink wavelength, but is blue or red shifted by about one thirds of the channel spacing to perform optical equalization. Further, according to an embodiment of the present disclosure, the 3 dB bandwidth of each pass-band is selected to be about half of the conventional AWG.

4. The specially designed AWG at the OLT side can simultaneously perform optical equalization for multiple uplink wavelength channels to improve the transmission performance of the high speed (10 Gb/s, for example) uplink optical signal which is generated by the low speed 2.5 Gb/s DML. The cost of the AWG according to the embodiment of the present disclosure can be shared by all the ONUs, so the cost of each ONU is maintained to be very low whilst the uplink bit rate for each ONU can be increased to 10 Gb/s, for example, without resorting to a high speed and expensive transmitter.

5. Reach extension and splitting ratio enhancement can be achieved in the TWDM-PON system by using the embodiments in the present disclosure. In the following, 60 km single mode fiber (SMF) transmission and 1:64 splitting ratio have been successfully validated for a 40 Gb/s symmetric TWDM-PON system using a low speed 2.5 Gb/s DML.

In the following, the embodiments of the present disclosure will be introduced. It should be understood, the embodiments disclosed herein are not limited to the four wavelength channels (i.e., N=4) for a 40 Gbs/s TWDM-PON disclosed in the following, and the uplink transmission rate of a single ONU is not limited to 10 Gb/s. For example, the principle of the embodiments of the present disclosure can also be extended to 8 channels or more for a 80 Gb/s or beyond symmetric TWDM-PON.

FIG. 1 illustrates a network architecture of a symmetric TWDM-PON system according to an embodiment of the present disclosure.

As shown in FIG. 1, the network architecture includes an OLT 10, a splitter 20 and multiple ONU 1 . . . n. Those ONU are connected with an OLT 10 via a transmission fiber through a splitter 20. Herein, the transmission distance is very long, longer than 20 km, for example.

a) Generation and Reception of a 40 Gb/s Downlink Optical Signal

Herein, the downlink direction (i.e., OLT to ONU direction) is described firstly.

In the downlink direction, the architectures of the transmitter of the OLT and the receiver of the ONU are similar as those of the conventional TWDM-PON system. As shown in FIG. 1, at the OLT side, the transmitter comprises four electro-absorption modulated lasers (EML) and AWG 101. Each EML can be used to independently generate four downlink wavelengths λ_{1d}, λ_{2d}, λ_{3d}, λ_{4d}. Herein, each wavelength is modulated at 10 Gb/s to generate the aggregate 40 Gb/s downlink capacity. Although the cost of each EML is about twice of the DML, it exhibits a superior transmission performance over a long distance single mode fiber (SMF) than the DML at 10 Gb/s. The total cost of the EML can be shared by all the ONUs, so it is acceptable to employ EML at the OLT side.

Further, a conventional AWG 101 with 100 GHz channel spacing and 3 dB bandwidth of ˜50 GHz can be used to multiplex the four wavelengths. Thus, the downlink multiple wavelength optical signals generated by the EMLs can be multiplexed to a downlink optical signal. Herein, the central wavelength of each AWG pass-band is aligned with the emission wavelength of the corresponding EML. To guarantee the power budget which depends on the splitting ratio and length of a single mode fiber (SMF), an optical amplifier 102 can be further used after the AWG 101 to compensate the loss in advance.

Herein, only one example of the transmitter at the OLT side is shown. It is appreciated for those skilled in the art that any other types of the transmitter in the prior art can also be applied.

Further, as shown in FIG. 1, an ONU (ONU 1, for example) includes a corresponding receiver to receive the downlink optical signal. This receiver can be constructed according to any suitable technology in the art. Further, the ONU further includes a wavelength division multiplexer 201 and a transmitter (discussed below). The wavelength division multiplexer 201 will be used to multiplex and de-multiplex the uplink optical signal and downlink optical signal.

b) Generation and Reception of a Symmetric 40 Gb/s Uplink Optical Signal

The optical signal transmission in the uplink direction will be introduced in the following according to the principal of the embodiments of the present disclosure.

In the uplink direction, the scheme of the embodiments of the present disclosure can be used to generate a 40 Gb/s uplink optical signal which is symmetric with the downlink. At the ONU transmitter side, instead of using an expensive EML, only a low cost and low speed 2.5 Gb/s bandwidth-limited DML is used. In one example of the present disclosure, the 2.5 Gb/s DML for each ONU is modulated with a high speed 10 Gb/s NRZ-OOK uplink data (It should be noted that the embodiments of the present disclosure are also possible to support ever higher transmission speed above 10 Gb/s, such as 20 Gb/s using only a low speed 2.5 Gb/s DML for a 80 Gb/s symmetric TWDM-PON). Herein, the 10 Gb/s uplink data is used only as an example for a 40 Gb/s symmetric TWDM-PON. Further, the modulation current can be selected properly according to the DML parameters.

At the OLT receiver 11, the receiver 11 can optionally include an optical amplifier 100 depending on the uplink power budget requirement. Herein, a special AWG 104 according to an embodiment of the present disclosure will be used to simultaneously perform wavelength de-multiplexing and optical equalization, so as to recover the distorted uplink 10 Gb/s NRZ-OOK signal for each wavelength channel. The 3 dB bandwidth and the center frequency of the special AWG are both different from those of the conventional AWG (e.g. the AWG 101 in the OLT transmitter for downlink transmission).

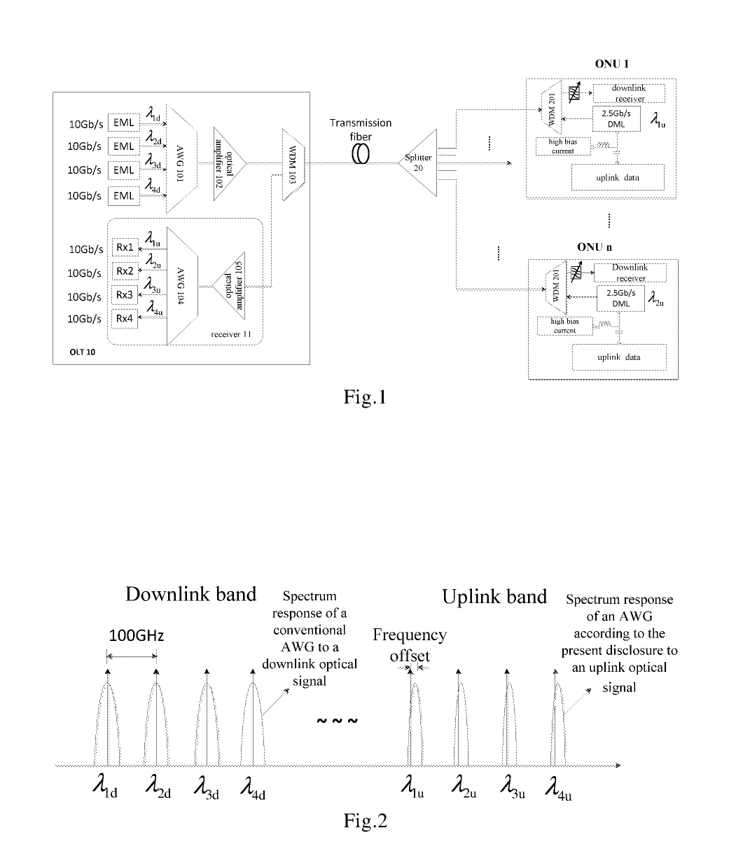

As illustrated in the right of FIG. 2, compared with the conventional AWG (The spectrum response of the AWG 101 is illustrated in the left of FIG. 2), the 3 dB bandwidth of the AWG according to the embodiment of the present disclosure is much narrower, and there is a frequency offset between the center frequency of each AWG pass-band and the corresponding uplink wavelengths λ₁ᵤ, λ₂ᵤ, λ₃ᵤ, λ₄ᵤ. The principle and construction of the ONU transmitter and the receiver in the OLT will be discussed as below.

ONU Uplink Transmitter Using a Low Speed 2.5 Gb/s DML

As shown in FIG. 1, the ONU uplink transmitter includes a low speed 2.5 Gb/s tunable DML, for generating the uplink optical signal.

Advantageously, the tunable DML could be a DFB or DBR laser.

According to an embodiment of the present disclosure, the modulation current with a high speed 10 Gb/s uplink NRZ-OOK data is combined with a high bias current to drive the 2.5 GHz DML.

This driving condition is different from the conventional DML operation. In the conventional DML operation, the bias current is near the threshold current of the DML, and a high modulation current is applied to get a high extinction ratio.

By contrast, in the embodiments of the disclosure, the bias current of each DML is set as greater than the threshold current (several times as the threshold current, for example) to produce a high output power and enhance the resonance frequency of the DML. Advantageously, the bias current is configured as at least three times of the threshold current of the DML. More advantageously, the bias current is configured as three to five times of the threshold current of the DML. Of course, the above bias current should be lower than the breakdown current of the DML.

Further, the peak modulation current of the 10 Gb/s uplink NRZ-OOK data is relatively small and the amplitude of the modulation current should be properly selected such that a difference between a frequency of 1 bit and a frequency of 0 bit of the uplink optical signal is a half of a transmission rate (10 Gb/s in this embodiment) of the uplink optical signal.

In practice, the amplitude of the modulation current should be also configured according to DML physical parameters. Those physical parameters include nonlinear gain compression, linewidth enhancement factor, confinement factor, volume, quantum efficiency and etc.

As an example, a distributed feedback laser with a multi-quantum-well active layer is used in the following for illustration. The threshold current of the DFB laser is ˜21 mA. Table 1 illustrates the physical parameters of the 2.5 Gb/s DML. A bias current of 80 mA and a modulation current of 20 mA are selected as per the above rules to modulate the 10 Gb/s uplink NRZ-OOK data onto the 2.5 Gb/s DML.

TABLE 1

| Parameter | value | Unit |
|---|---|---|
| Wavelength | 1550 | nm |
| Confinement factor | 0.1 | / |
| Carrier density at transparency | 1.8 * 10¹⁸ | cm⁻³ |
| Gain compression factor | 4.5 * 10⁻¹⁷ | cm³ |
| Photon lifetime | 1.367 | ps |
| Electron lifetime | 0.66 | ns |
| Spontaneous emission factor | 10⁻⁴ | / |
| Active region volume | 3 * 10⁻¹¹ | cm⁻³ |
| Group velocity | 7.494 * 10⁹ | cm/s |
| Gain constant | 7 * 10⁻¹⁶ | cm² |
| Differential quantum efficiency | 0.1945 | / |
| Linewidth enhancement factor | 3.3 | / |

OLT Receiver Structure with an AWG According to an Embodiment of the Present Disclosure

As shown in FIG. 1, the receiver 11 in the OLT includes an AWG 104 according an embodiment of the present disclosure and N receiving units (N=4 in FIG. 1). Advantageously, the receiver 11 further includes an optical amplifier for amplifying the uplink optical signal and outputting it to the AWG 104.

The uplink 10 Gb/s NRZ-OOK optical signal for each ONU is combined by the splitter and transmitted over a long distance before arriving at the OLT. Due to the large chromatic dispersion introduced by the SMF, the uplink 10 Gb/s optical signal generated by the 2.5 GHz band-limited DML will be greatly distorted.

According to an embodiment of the present disclosure, at the OLT receiver, the AWG 104 de-multiplexes the uplink optical signal to multiple uplink multiple wavelength signals (four uplink multiple wavelength signals in FIG. 1), and equalize the uplink optical signal in the meantime. After then, the AWG 104 outputs the respective uplink multiple wavelength signal to the corresponding receiving unit. Herein, the AWG 104 is able to perform optical equalization for all the four uplink wavelength channels. Thus, the AWG 104 according to the embodiment of the present disclosure is different from the conventional one.

The 3 dB bandwidth of each pass-band for the AWG 104 according to the embodiment of the present disclosure is set around half of that of the conventional AWG. Compared with the corresponding uplink wavelength channel λ₁ᵤ, λ₂ᵤ, λ₃ᵤ, λ₄ᵤ, the corresponding center frequency of the AWG is blue or red shifted by about one thirds of the channel spacing, thereby generating offset with respect to the frequency of the corresponding uplink multiple wavelength optical signal.

Advantageously, the offset is in a range of 25 GHz to 35 GHz. More advantageously, the offset is 30 GHz.

In one embodiment of the present disclosure, the bandwidth of the N pass-bands of the AWG 104 is located in the range of 17 GHz to 33 GHz respectively. More advantageously, the bandwidth of the N pass-bands of the AWG 104 is 25 GHz.

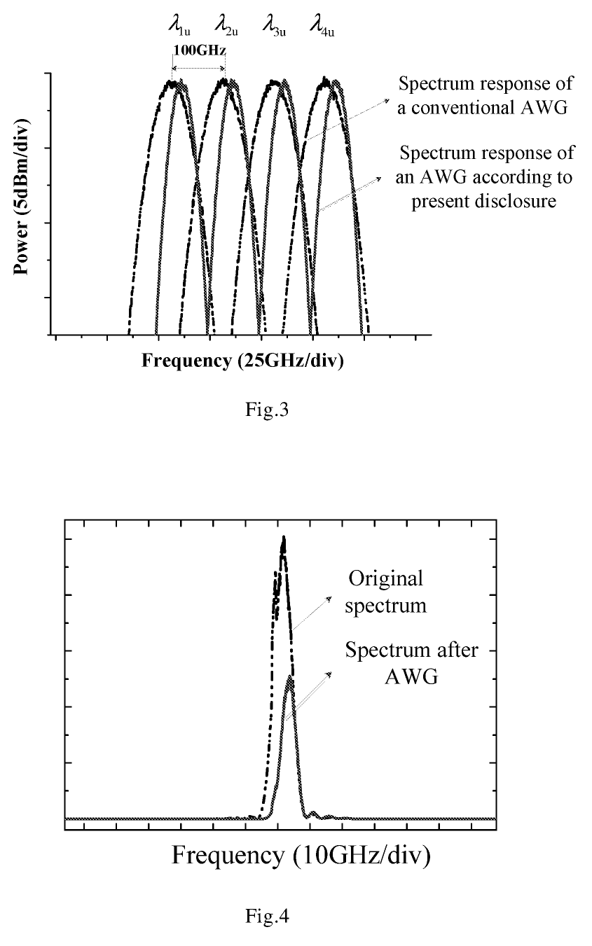

FIG. 3 illustrates a spectrum response of a conventional AWG according to another embodiment of the present disclosure and a spectrum response of an AWG according to an embodiment of the present disclosure. As shown in FIG. 3, the 3 dB bandwidth of the AWG is ˜25 GHz, which is lower than 50 GHz 3 dB bandwidth of the conventional AWG. Further, the center frequency has a frequency offset with respect to the uplink wavelength by around 30 GHz. Through the specially designed AWG 104, the transmission performance of the uplink 10 Gb/s NRZ optical signal generated by a low speed 2.5 Gb/s DML can be greatly improved. Through the above configuration, it can be guaranteed that BER after a long distance fiber (60 km, for example) is still within the correction range 10̂⁽⁻³⁾ of the forward error correction.

Further, according to an embodiment of the present disclosure, an order of a filter of each of the N pass-bands of the AWG 104 is at least 2.

FIG. 4 illustrates the spectrums of the uplink optical signal before and after the AWG according to an embodiment of the present disclosure. Since the center frequency of the AWG is shifted, the output spectrum has been reshaped. The blue part of the spectrum of each uplink multiple wavelength optical signal has been slightly cut-off, while the red part is maintained. Thanks to the spectrum reshaping, the uplink 10 Gb/s optical signal has been regenerated precisely.

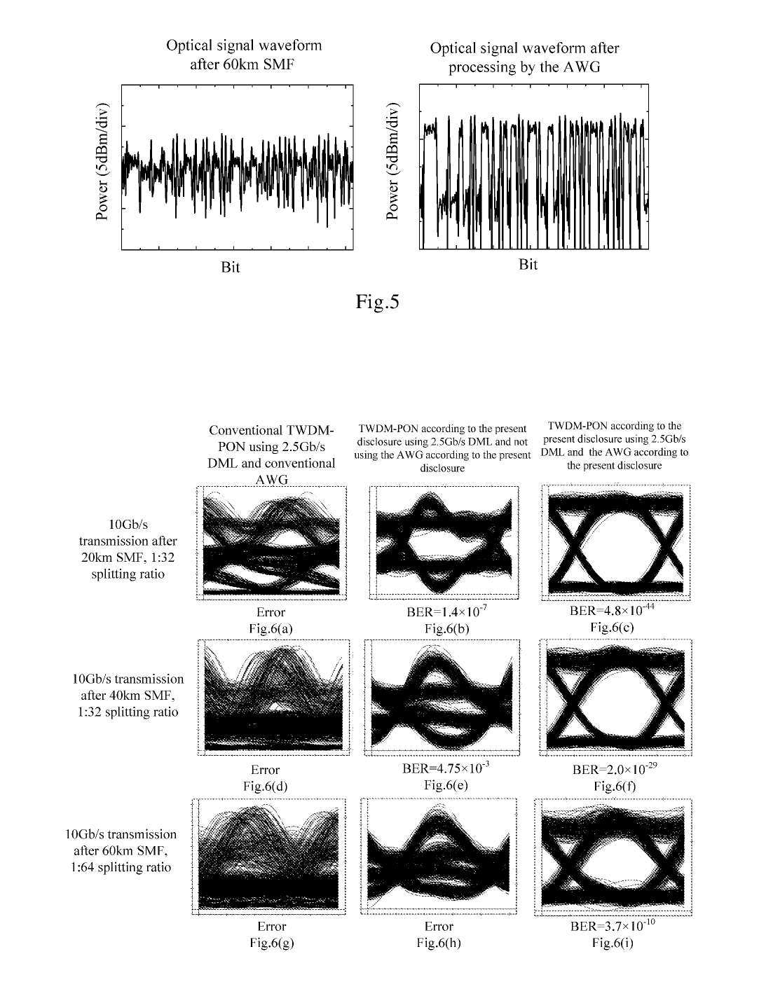

As shown in the left of FIG. 5, the waveform after 60 km SMF transmission has been greatly distorted and fully submerged under the noise. However, after the process by the AWG 104 according to the embodiment of the present disclosure, the 10 Gb/s uplink optical signal has been successfully recovered, as shown in the right of FIG. 5.

FIGS. 6(a) to 6(i) illustrate eye diagrams and BER diagrams under the respective condition when the bit rate is 10 Gb/s according to an embodiment of the present disclosure. It should be noted that no any optical amplifier is used throughout those simulation. FIGS. 6(a) to 6(i) illustrate the transmission performance for different transmission distance and splitting ratio condition.

As shown in FIG. 6(a), in the case of 20 km SMF transmission and 1:32 splitting ratio, the eye diagram of 10 Gb/s NRZ signals is substantially closed for the conventional TWDM-PON using a 2.5 Gb/s DML. Herein, the 2.5 Gb/s DML is driven by the bias current near the threshold current and a modulation current with a higher amplitude. In this situation, no bit-error-ratio (BER) can be measured.

However, as shown in FIG. 6(b), under the same condition, the symmetric TWDM-PON system proposed according to the embodiment of the present disclosure is used, which is configured with a DML transmitter driven with a high bias current and a modulation current with a lower amplitude, and the AWG according to the embodiment of the present disclosure is not used at the OLT receiver side. As shown in FIG. 6(b), in this case, the eye diagram is partially open with a BER 1.4×10⁻⁷. Further, in FIG. 6(c), the AWG according to an embodiment of the present disclosure is used at the OLT receiver side. It is clear that BER is significantly reduced to 4.8×10⁻⁴⁴ under the same condition.

For comparison, FIGS. 6(d) to 6(f) illustrate the transmission performance of 10 Gb/s NRZ signal when the transmission distance is extended to 40 km for a splitting ratio of 1:32.

As shown in FIG. 6(d), the eye diagram for the 10 Gb/s NRZ signal when a conventional TWDM-PON employs the 2.5 Gb/s DML is severely closed. Herein, the 2.5 Gb/s DML is driven by the bias current near the threshold current and a modulation current with a higher amplitude. In this situation, no BER can be measured.

However, as shown in FIG. 6(e), under the same condition, the symmetric TWDM-PON system proposed according to the embodiment of the present disclosure is used. The TWDM-PON is configured at the ONU side with a DML transmitter driven by a high bias current and a modulation current with a lower amplitude, and no AWG according to the embodiment of the present disclosure is used at the receiver of the OLT. As shown in FIG. 6(e), in this case, the transmission performance is slighted degraded, and the BER is 4.75×10⁻³. Further, in FIG. 6(c), an AWG according to the embodiment of the present disclosure is used at the side of the receiver of the OLT, it can be clearly seen that the BER is significantly reduce to 2×10⁻²⁹ under the same condition. Herein, the eye diagram is still clearly open. Thus, the scheme according to the embodiment of the disclosure can accomplish a reliable long distance transmission.

FIGS. 6(g) to 6(i) illustrate the transmission performance of the 10 Gb/s NRZ signal when the transmission distance and splitting ratio are both extended to 60 km and 1:64.

FIG. 6(i) illustrates the eye diagram in the following situation, where the proposed TWDM-PON system is used, which is configured at the ONU side with a DML transmitter driven by a high bias current and a modulation current with a lower amplitude, and at the receiver of the OLT side uses an AWG according to an embodiment of the present disclosure. As shown in FIG. 6(i), the eye diagram is totally open, and thus the error free long distance transmission can be accomplished.

For the two situations where the conventional TWDM-PON is used and the AWG according to the embodiment of the present disclosure is not used, the eye diagrams of FIGS. 6(i) and 6(h) are totally closed, and thus the transmission will produce error and no BER can be measured.

Through the simulation from FIGS. 6 (a) to 6(i), the embodiment of the present disclosure can accomplish a long reach and precise 40 Gb/s symmetric TWDM-PON system when using a low speed and low cost 2.5 Gb/s DML and an AWG according to an embodiment of the present disclosure.

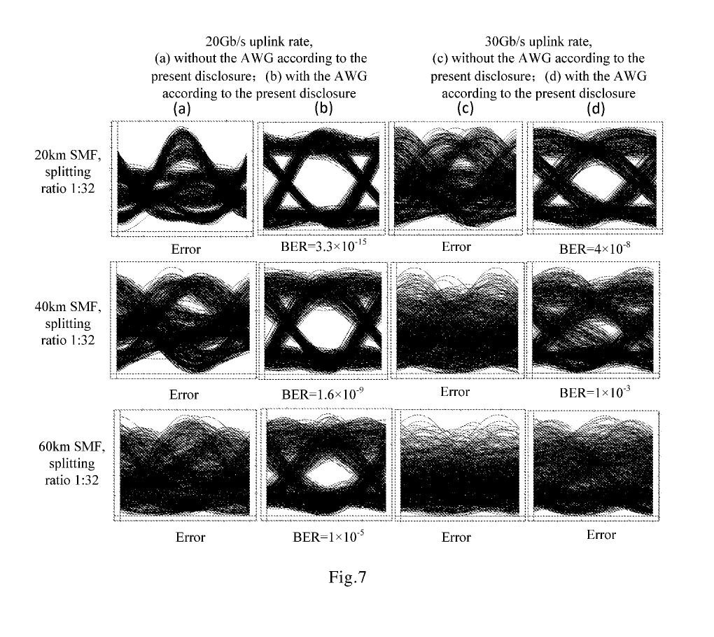

When the transmission distance and the splitting ratio are reduced, the scheme of the embodiment according to the present disclosure can further accomplish a higher rate uplink transmission. FIG. 7 illustrates eye diagrams and BER diagrams under the respective condition when the bit rate is 20 Gb/s and 30 Gb/s according to an embodiment of the present disclosure.

As shown in column b in FIG. 7, when the bit rate is increased to 20 Gb/s per wavelength and the splitting ratio is 1:32, if the proposed symmetric TWDM-PON system is used, which is configured at the ONU side with a DML transmitter driven by a high bias current and a modulation current with a lower amplitude and at the receiver of the OLT side uses an AWG according to an embodiment of the present disclosure, the clearly opened eye diagram is obtained for the transmission distance 20 km, 40 km and 60 km. And the corresponding BER is 3.3×10⁻¹⁵, 1.6×10⁻⁹ and 1×10⁻⁵ respectively, which are in the approved range of the forward error correction. By contrast, if the AWG according to the embodiment of the disclosure is not used, error would be generated (seen in column a in FIG. 7).

Further, as shown in column d in FIG. 7, when the bit rate is further increased to 30 Gb/s per wavelength, in the situation where the transmission length is 20 km and the splitting ratio is 1:32, a clear eye diagram can also be obtained and the BER is 4×10⁻⁸. Thus, a higher bit rate transmission can be accomplished with the AWG according to the embodiment of the present disclosure and the DML driven according to the embodiment of the present disclosure.

It shall be appreciated that the foregoing embodiments are merely illustrative but will not limit the invention. Any technical solutions without departing from the spirit of the invention shall fall into the scope of invention, including that different technical features, methods appearing in different embodiments are used to combine to advantage. Further, any reference numerals in the claims cannot be recognized as limiting the related claims; the term “comprise” will not preclude another apparatus or step which does not appear in other claims or the description.

1. A transmitter for an optical network unit, comprising:
a 2.5 Gb/s direct modulation laser, for generating an uplink optical signal;
wherein the direct modulation laser is driven by a modulation current and a bias current, and the bias current is configured to be greater than a threshold current of the direct modulation laser, and an amplitude of the modulation current is configured such that a difference between a frequency of 1 bit and a frequency of 0 bit of the uplink optical signal is a half of a transmission rate of the uplink optical signal.

2. The transmitter according to claim 1, wherein the direct modulation laser comprises a distributed feedback laser or a distributed Bragg reflector.

3. The transmitter according to claim 1, wherein the bias current is configured to be at least three times of the threshold current of the direct modulation laser.

4. The transmitter according to claim 3, wherein the bias current is configured to be three to five times of the threshold current of the direct modulation laser.

5. The transmitter according to claim 1, wherein data carried by the modulation current is in an On-Off Keying format.

6. The transmitter according to claim 1, wherein the amplitude of the modulation current is configured based on physical parameters of the direct modulation laser.

7. A receiver for an optical line terminal, comprising:
an arrayed waveguide grating; and
N receiving units;
wherein the arrayed waveguide grating is used to equalize an uplink optical signal, and transmit N uplink multiple wavelength optical signals to the N receiving units respectively, wherein the uplink optical signal is generated by a 2.5 Gb/s direct modulation laser; and
wherein a center frequency of each of N pass-bands of the arrayed waveguide grating has an offset with respect to a frequency of a corresponding uplink multiple wavelength signal, and a 3 dB bandwidth of each of the N pass-bands of the arrayed waveguide grating is in a range of 17 GHz to 33 GHz.

8. The receiver according to claim 7, wherein the 3 dB bandwidth of each of the N pass-bands of the arrayed waveguide grating is 25 GHz.

9. The receiver according to claim 7, wherein the offset between the center frequency of each of the N pass-bands of the arrayed waveguide grating and the frequency of the corresponding uplink multiple wavelength optical signal is in a range of 25 GHz to 35 GHz.

10. The receiver according to claim 9, wherein the offset is 30 GHz.

11. The receiver according to claim 7, wherein N equals to 4 or 8, and/or an order of a filter of each of the N pass-bands of the arrayed waveguide grating is at least 2.

12. (canceled)

13. The receiver according to claim 7, wherein the receiver further comprises:
an optical amplifier, for amplifying the uplink optical signal and outputting it to the arrayed waveguide grating.

14. The receiver according to claim 7, wherein the direct modulation laser is driven by a modulation current and a bias current, and the bias current is configured to be greater than a threshold current of the direct modulation laser, and an amplitude of the modulation current is configured such that a difference between a frequency of 1 bit and a frequency of 0 bit of the uplink optical signal is a half of a transmission rate of the uplink optical signal.

15. An optical network unit, comprising:
a transmitter according to claim 1;
a receiver; and
a wavelength division multiplexer connected with the transmitter and the receiver respectively.

16. An optical line terminal, comprising:
a receiver according to claim 7;
a transmitter; and
a wavelength division multiplexer connected with the transmitter and the receiver respectively.

17. (canceled)
